(19) United States
(12) Patent Application Publication
(10) Pub. No.: US 2024/0126960 A1
(43) Pub. Date: Apr. 18, 2024

(54) Intelligent Suggestions for CAD-Based Design Entry

(71) Applicant: Altera Corporation, San Jose, CA (US)

(72) Inventors: Yi Peng, Newark, CA (US); Nathan Edward Krueger, Kalispell, MT (US); Krishna Kumar Nagar, Union City, CA (US); Brandon Lewis Gordon, Campbell, CA (US)

(21) Appl. No.: 18/398,699

(22) Filed: Dec. 28, 2023

(51) Int. Cl. G06F 30/31; G06F 30/27; G06F 30/34

(52) U.S. Cl. CPC G06F 30/31; G06F 30/27; G06F 30/34; G06F 2111/20

(57) ABSTRACT

Systems and methods may provide recommendations for a circuit design based on components of the circuit and machine-learning techniques. For example, a system may include a processor-based device storing or accessing a computer-aided design application for an integrated circuit, where the computer-aided design application, when executed by the processor-based device, causes acts to be performed including receiving an indication of a first selected component from a library for a design for the integrated circuit, retrieving one or more suggested components from the library based at least in part on the first selected component, and populating a user interface with the first selected component and a first suggested component of the one or more suggested components for display on the processor-based device.

### BACKGROUND

The present disclosure relates generally to programmable logic devices. More particular, the present disclosure relates to reducing design time for the programmable logic devices, such as high-capacity field programmable gate arrays (FPGAs).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Programmable logic devices, a class of integrated circuits, may be programmed to perform a wide variety of operations. The programmable logic device may implement a circuit design generated using computer-aided design (CAD) tools, which may involve many highly detailed steps. For example, different high-level operations may include similar user inputs and/or design patterns. In another example, the high-level operations may include different components and/or coupling between the components. As such, the design process may be both time-consuming and repetitive.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of a design system used to implement a circuit design onto the integrated circuit device of FIG. 1, in accordance with an embodiment of the present disclosure;

FIG. 4 is a block diagram of a block-based circuit design with one or more selected components and a recommended component, in accordance with an embodiment of the present disclosure;

FIG. 5 is a schematic view of a user interface as a patch panel with a component for the circuit design, in accordance with an embodiment of the present disclosure;

FIG. 6 is a schematic view of the user interface of FIG. 5 with selected components for the circuit design, in accordance with an embodiment of the present disclosure;

FIG. 7 is a schematic view of the user interface of FIG. 5 with the selected components for the circuit design, in accordance with an embodiment of the present disclosure;

FIG. 8 is a schematic view of the user interface as a schematic user interface (UI) with a component for the circuit design, in accordance with an embodiment of the present disclosure;

FIG. 9 is a schematic view of the user interface of FIG. 8 with selected components for the circuit design, in accordance with an embodiment of the present disclosure;

FIG. 10 is a schematic view of the user interface of FIG. 8 with the selected components for the circuit design, in accordance with an embodiment of the present disclosure;

FIG. 11 is a schematic view of the user interface of FIG. 8 with the selected components for the circuit design, in accordance with an embodiment of the present disclosure;

FIG. 12 is a flowchart of an example method for generating a circuit design using a tool, in accordance with an embodiment of the present disclosure; and

FIG. 13 is a flowchart of an example method for training a machine-learning technique used by the tool, in accordance with an embodiment of the present disclosure; and

FIG. 14 is a block diagram of a data processing system that may incorporate the integrated circuit, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another.

Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure describes systems and techniques related to a design system that recommends one or more components for a circuit design that may be implemented onto integrated circuitry, such as a high-capacity field programmable gate arrays (FPGAs), thereby decreasing design time. In particular, the embodiments described herein are directed to a tool, such as a schematic editor and/or a system block-based builder, within the design system that recommends components based on selected components. For example, a user may select a component (e.g., graphical representation of a component, block representation of a component) from a library (e.g., database) for a circuit design. The tool may provide a visual representation of the component for the user on a user interface (e.g., graphical user interface). Based on the selected component, the tool may provide a graphical representation of one or more recommended components for the circuit design. The recommendation may be visually distinguishable from the selected component. For example, the component may be illustrated with solid lines and the recommendation may be illustrated with dashed lines. In another example, the recommendation may be highlighted while the selected component may not be highlighted. In addition, the tool may overlay a description of the recommendation over the graphical representation along with two arrows to allow the user to toggle through the recommended components. As such, the user may view the recommended components, select a recommended component for implementing into the circuit design, or decline the recommended components, thereby reducing a number of operations performed by the user.

In certain instances, the recommendation may include one or more components and connections between the recommendations and the selected component. For example, the tool may identify and display two recommended components and as well as eight connections between the recommended and the selected component. The user may accept all of the recommendations, some of the recommendations, or decline all of the recommendations. Additionally or alternatively, the user may manually connect (e.g., couple) the recommended component to the selected component. However, the tool may determine the connection may be incorrect or may be adjusted to improve efficiency of the circuit design. As such, the tool may provide a recommendation to the user to adjust the connection. As such, the tool may improve design efficiency.

To provide the recommendations, the tool may implement machine-learning techniques, such as an artificial intelligence algorithm, a machine learning model, and the like to provide the recommendations. To this end, the tool may be trained using completed circuit designs created by a manufacturer, one or more users of the tool, user input (e.g., accepting a recommendation, declining a recommendation), and the like. As such, the likelihood of a recommendation being accepted by the user may increase. Over time, recommendations provided by the tool may increase in accuracy and/or likelihood of applicability. By providing accurate recommendations, a number of errors that may stem from human errors may be reduced, an amount of time and resources used to design the FPGA may be reduced, and productivity may be increased. Additionally or alternatively, these recommendations can aid a novice user by suggesting what a likely next course of action is for other users.

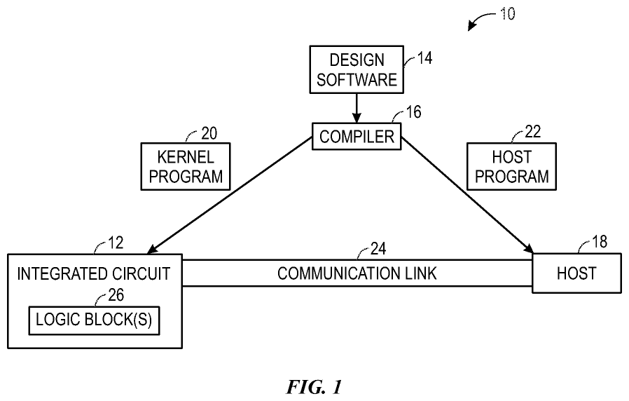

With the foregoing in mind, FIG. 1 illustrates a block diagram of a system 10 that may be used to implement the iterative modular multiplication of this disclosure on an integrated circuit system 12 (e.g., a single monolithic integrated circuit or a multi-die system of integrated circuits). A designer may desire to implement iterative modular multiplication on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks 110 on the integrated circuit system 12. The programmable logic blocks 110 may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

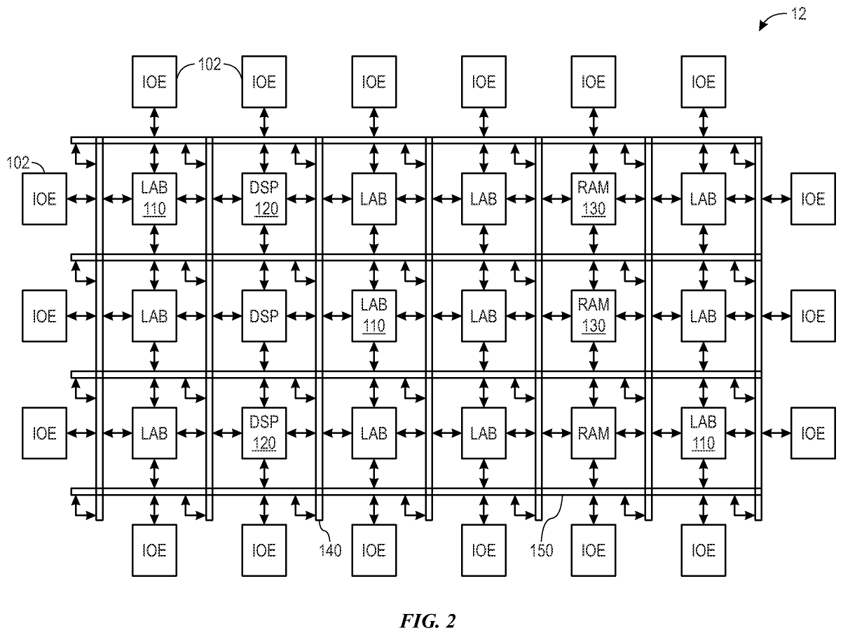

An illustrative embodiment of a programmable integrated circuit system 12 such as a programmable logic device (PLD) that may be configured to implement a circuit design is shown in FIG. 2. As shown in FIG. 2, the integrated circuit system 12 (e.g., a field-programmable gate array integrated circuit) may include a two-dimensional array of functional blocks, including programmable logic blocks 110 (also referred to as logic array blocks (LABs) or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic the integrated circuit system 12 may contain programmable memory elements. Memory elements may be loaded with configuration data (also called programming data or configuration bitstream) using input-output elements (IOEs) 102. Once loaded, the memory elements each provide a corresponding static control signal that controls the operation of an associated functional block (e.g., LABs 110, DSP 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements.

Programmable logic device (PLD) 100 may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the integrated circuit system 12) and horizontal routing channels 150 (i.e., interconnects formed along a horizontal axis of the integrated circuit system 12), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the present invention. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

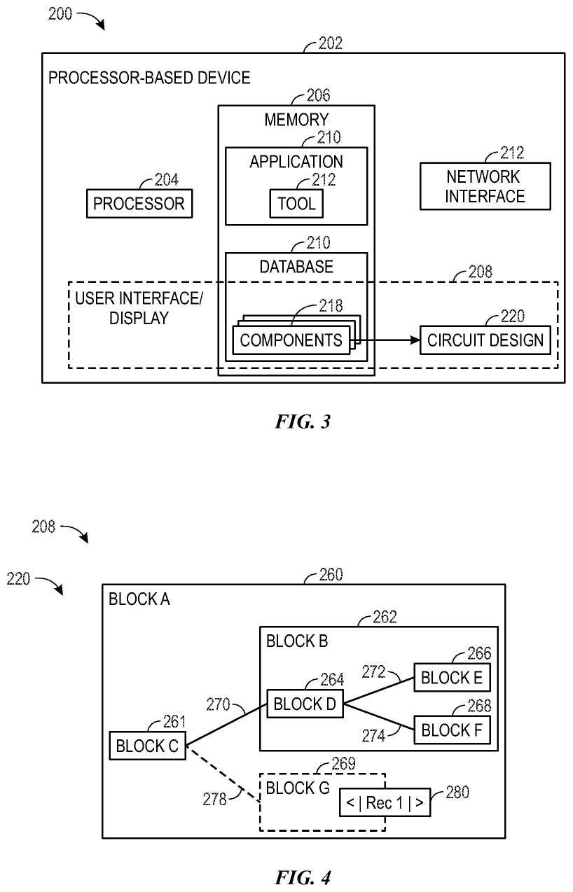

The integrated circuit system 12 may be programmed by the designer to perform a wide variety of operations. With the foregoing in mind, FIG. 3 is a block diagram of a design system 200 used to implement a circuit design onto the integrated circuit system 12. The design system 200 may include one or more processor-based devices 202. The term “processor-based device” may include, for example, any suitable type of computing device, including portable computing devices (e.g., smartphone, tablet, computer, wearable computer, etc.), workstations, desktop computers, servers, and so on. The processor-based device 202 may include a communication component, a processor 204, a memory 206, stored instructions, input/output (I/O) ports, a user interface (e.g., display) 208, and a database 210, and the like. Additionally, or alternatively, the processor-based device 202 may be communicatively coupled to a server (e.g., cloud server, database) and receive updates from the server via a network interface 212. The processor-based device 202 may also include various types of components that may assist the processor-based device 202 in performing various types of tasks and operations. For example, the processor-based device 202 can include one or more processors 204, which can include any processing device, such as a microprocessor, microcontroller, integrated circuit, logic device, and/or other suitable processing device.

During operation, the processor-based device 202 may store and/or execute an application (e.g., computer-aided design (CAD) software) 211 with a tool 213 (e.g., user interface plug-in) to generate different designs. The application 211 may include the design software 14 described with respect to FIG. 1 and may be used to implement one or more component(s) 218 to generate a circuit design 220 that may be implemented on the integrated circuit system 12. The components 218 may include, but not limited to, a processor (e.g., NiosV, MicroBlaze), a memory (e.g., high-bandwidth memory, on-chip memory, off-chip memory, RAM 130, read-only memory (ROM)), a clock bridge, a reset bridge, a input-output element 102 (e.g., general purpose IO (GPIO), high-speed IO (HSIO), on-package IO (OPIO)), a lookup table (LUT), a multiplexer, a DSP 120, a switch, a sector controller, a router, a device controller, a function block, a register, and so on. Additionally or alternatively, the component(s) 218 may be used for implementing an operation, a constant value, an operator, a functionality, and/or the like onto the integrated circuit system 12. The component(s) 218 may also include one or more routing resources, such as bus routes, communication wires, and the like.

The component(s) 218 may be stored in the database 210. Each component may be stored with a corresponding description (e.g., text string, identifier) in the database 210. The component(s) 218 may be generated by a manufacturer, a user (e.g., designer), other users (e.g., designers), third parties, and/or any other suitable source. Additionally, the component(s) 218 may be periodically updated by the manufacturer and/or other users and transmitted to application 211 to update the database 210. For example, a manufacturer may redesign one of the component(s) 218 to improve implementation efficiency and/or increase flexibility with additional options and transmit an indication of the redesigned component 218 to the database 210 for storage. Additionally or alternatively, the redesigned component 218 may be downloadable from a cloud repository (via the network interface 212), bundled in the application 211, stored in memory 206 (e.g., flash or CD-ROM), or the like. In another example, the user may upload one or more customized component(s) 218 to the database 210 and/or the cloud server. The user may provide an indication to keep the customized component(s) 218 private or to share the customized component(s) 218 in the cloud server for other users to use in respective circuit designs 220. To this end, the user may upload a bitstream (e.g., configuration bitstream) corresponding to the customized component(s) 218 via the application 211 and tag the bitstream with an identifier (e.g., text description) for storage.

The database 210 may be stored in the memory 206 of the processor-based device 202. The memory 206 can include one or more computer-readable media including, but not limited to, a non-transitory computer-readable medium, RAM, ROM, hard drives, flash drives, and/or other memory devices. The memory 206 can store information accessible by the one or more processors 204, including computer-executable or computer-readable instructions that can be executed by the one or more processors 204. The instructions can be any set of instructions that, when executed by the one or more processors 204, cause the one or more processors 204 to perform operations. In some embodiments, the instructions can be executed by the one or more processors 204 to perform operations, such as any of the operations and functions for which the design system 200 is configured. The instructions can be software written in any programming language or can be implemented in hardware. Additionally, and/or alternately, the instructions can be executed in logically and/or virtually separate threads on processors 204. The memory 206 can further store data that can be accessed by the processors 204.

Additionally, or alternatively, the database 210 may be stored in the server (e.g., cloud server) and may be accessible to the processor-based device 202. The processor-based device 202 may communicate with the server via the network interface 212. The network interface 212 is used to communicate, for example, with other components of the design system 200. The network interface 212 can include components for interfacing with one or more networks, including, for example, transmitters, receivers, ports, controllers, antennas, and/or other suitable components.

The create a circuit design 220, the user may interact with the user interface 208. For example, the user may select one or more component(s) 218 from the database 210 and the tool 213 may populate the user interface (e.g., display, graphical user interface) 208 of the processor-based device 202 with a visual representation (e.g., schematic representation, graphical representation, block-diagram) of the selected component 218. Based on the recommendation, the tool 213 may also provide one or more recommendations based on the selected component 218. The recommendations may include one or more additional component(s) 218 that may be coupled to the selected component 218 and/or one or more connections between the component(s) 218.

For example, the tool 213 may populate the user interface 208 with the recommendation. To distinguish between the selected component 218 and the recommended component 218, the tool 213 may display the recommended component 218 with dashed lines, highlights, a lower opacity, and the like while displaying the selected component 218 with solid lines, no highlights, 100% opacity, and the like. As such, the user may easily perceive the recommended component 218 as recommendations (e.g., pending). The tool 213 may also overlay a short name and/or description of the recommendation along with buttons (e.g., arrows). The tool 213 may provide multiple recommended component(s) 218 for the circuit design 220 based on the selected component 218. For example, the tool 213 may implement the machine-learning techniques to identify the recommendations based on selected component(s) 218, previously accepted recommended component(s) 218, user input, relationships between the component(s) 218, and the like. The user may toggle through the recommended component(s) 218 by clicking on the buttons and select a recommendation for implementing into the circuit design 220 by clicking on the recommended component. Additionally or alternatively, the user may toggle through the recommendations by pressing a key on an input device, such as by pressing the Escape (Esc) key to decline the recommendation and/or by pressing the Enter key to accept the recommendation. As such, a number of clicks used by the user to create the circuit design 220 may be reduced. As will be discussed herein, the user may accept all of the recommendations, accept a portion of the recommendations, decline a portion of the recommendations, decline all of the recommendations, and so on. As such, the tool 213 may reduce a number of steps performed by the user to generate the circuit design 220.

The circuit design 220 may be a low-level hardware description that may be implemented onto the integrated circuit system 12. For example, the circuit design 220 may implement a functionality on the integrated circuit system 12. The application 211 may provide the circuit design 220 to a complier (e.g., the compiler 16 described with respect to FIG. 1) to generate a low-level circuit-design program (bitstream). That is, the complier may provide machine-readable instructions representative of the circuit design 220 to the integrated circuit system 12. The low-level circuit design program may be programmed into the integrated circuit system 12 as a configuration program. As such, the circuit design 220 may be implemented onto the integrated circuit system 12.

Returning to the tool 213, the tool 213 may reduce a number of operations performed by the user (e.g., designer) to generate the circuit design 220, thereby increasing efficiency of design operations. To this end, the tool 213 may implement machine-learning techniques (e.g., a machine learning model, artificial intelligence algorithms) to identify one or more component(s) 218 selected by the user for the circuit design 220, recommend one or more additional component(s) 218 based on the identified component(s) 218, and implement the additional component(s) 218 in response to receiving user input indicative of accepting the recommendation. For example, the tool 213 may use and/or implement a natural language model that may be trained using completed (e.g., published) circuit designs from the manufacturer, the user, other users, and/or other sources. The natural language model may identify relationships between one or more component(s) 218, such as commonly coupled component(s) 218, commonly coupled input/output elements of each component 218, and the like based on the completed circuit designs. Additionally or alternatively, the model may be continuously trained using user input indicative of the user accepting all recommendations, accepting a portion of the recommendations, declining all recommendations, declining a portion of the recommendations, selecting additional component(s) 218, and so on. In this way, the tool 213 may continuously fine-tune the recommendations provided to the user to generate the circuit design 220, which may improve design efficiency.

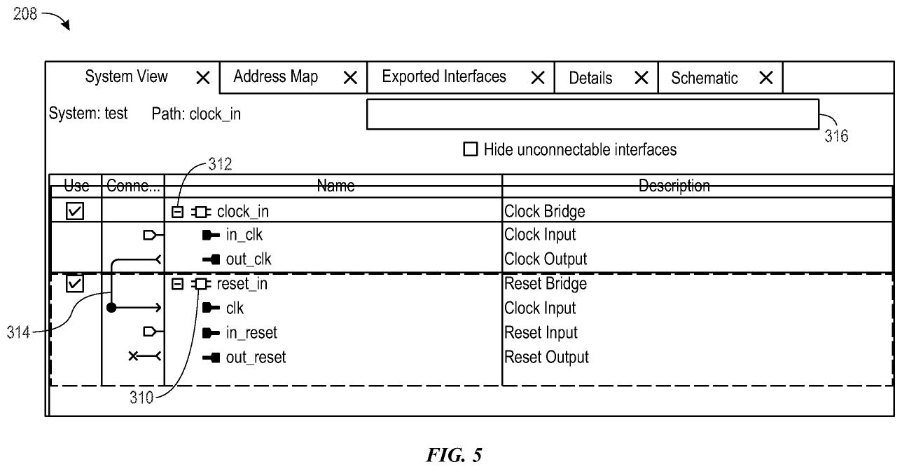

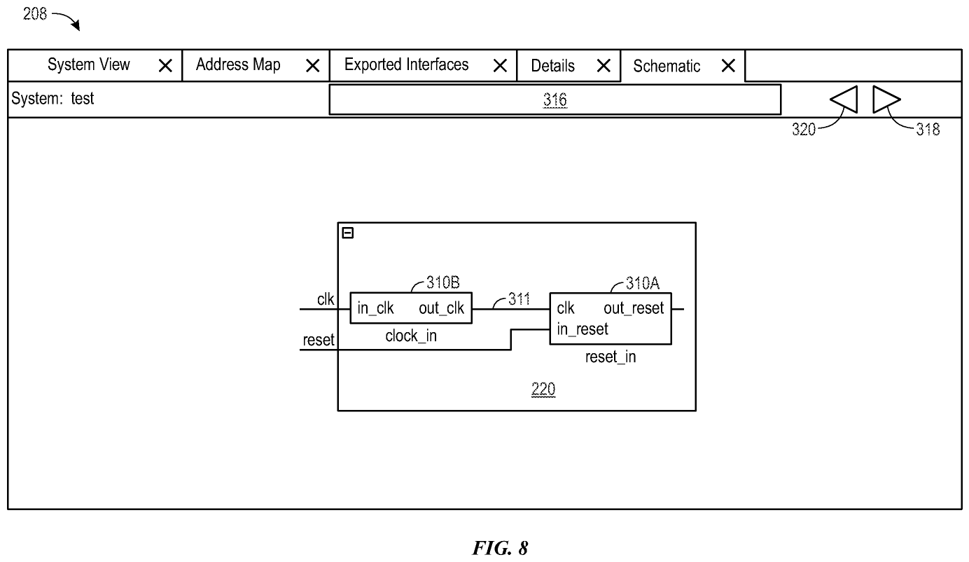

With the foregoing in mind, FIGS. 4-11 illustrate example embodiments of the component(s) 218 used within the circuit design 220 and/or implemented on the integrated circuit system 12. In particular, FIG. 4 is a block diagram of the user interface 208 populated with a block representation of the circuit design 220 that includes selected component(s) and a recommended component, FIGS. 5-7 is a schematic diagram of the user interface 208 as a patch panel populated with a visual representation of the circuit design 220 that includes selected component(s) and recommended components, and FIGS. 8-11 is a schematic diagram of the user interface 208 as a schematic user interface (UI) populated a visual representation of the circuit design 220 that includes selected components and recommended components. The user interface 208 may display each component of the circuit design 220 with a number of high-level abstracted interfaces for the user to make connections. For example, the user may select a first interface and subsequently select a second interface to couple together two components. As discussed herein, the tool 213 may populate the user interface 208 with one or more recommended components based on the selected components used in the circuit design 220. The tool 213 may also recommend one or more connections between the selected components and/or the recommended component to reduce a number of operations performed by the user to generate the circuit design 220. It should be appreciated that discussion with regard to circuit designs 220 for integrated circuit system 12 is merely intended to be illustrative and not limiting. In other words, the techniques described in the present disclosure may be applied to and/or adapted for other computer-aided design tools that may be used to generate a circuit design, whether for programmable logic circuitry (e.g., an FPGA) or for static circuitry (e.g., an ASIC).

With the foregoing in mind, FIG. 4 is a block diagram of the user interface 208 populated with a block representation of the circuit design 220 that includes selected components 260, 261, 262, 264, 266, 268, and a recommended component 269. As discussed herein, the tool 213 may provide the recommended component 269 based on the selected components 260, 261, 262, 264, 266, 268 and/or one or more connection components 270, 272, and 274 between the components. Additionally, the tool 213 may provide a visual distinction between the recommended component 269 and the selected components 260, 261, 262, 264, 266, 268, which may improve design operations. For example, recommendations provided by the tool 213 may be provided in dashed lines, different coloring, highlighting, a lower opacity, while the selected components may be provided in solid lines, black lines, no highlighting, and 100% opacity.

As illustrated, the circuit design 220 may include a first selected component (Block A) 260 coupled to a second selected component (Block B) 262. The first selected component 260 may include a third selected component (Block C) 261 and the second selected component 262 may include a fourth selected component (Block D) 264, a fifth selected component (Block E) 266, and a sixth selected component (Block F) 268. The third selected component 261 may be coupled to the fourth selected component 264 via a first connection component 270. The fifth selected component 266 and the sixth selected component 268 may be coupled to the fourth selected component 264 via a second connection component 272 and a third connection component 274, respectively. The selected components 260, 261, 262, 264, 266, 268 and the connection components 270, 272, and 274 and the second selected component 262 are represented by solid lines, which may indicate that the components are part of the circuit design 220.

Based on the selected components 260, 261, 262, 264, 266, 268, the tool 213 may provide one or more recommended component(s) 269 and/or recommended connection components 269 to adjust the circuit design 220. As illustrated, the tool 213 may provide the recommended component (Block G) 269 to add to the circuit design 220. The tool 213 may identify recommended component 269 based on at least one of the selected components 260, 261, 262, 264, 266, 268 and recommend one or more components for the user to implement into the circuit design 220. For example, the tool 213 may identify the recommended component 269 based at least in part on the third selected component 261. Additionally or alternatively, the tool 213 may provide the recommended component 269 based on the second selected component 262, the fourth selected component 264, the fifth selected component 266, and/or the sixth selected component 268.

While the tool 213 provides the recommended component 269 based on the selected components 260, 261, 262, 264, 266, 268 in the illustrated example, it may be understood that the tool 213 may provide a recommended component 269 based on any of the selected components 260, 261, 262, 264, 266, 268. For example, the tool 213 may recommend components 269 and 278 in response to the user selecting component 261 for the circuit design 220. In another example, the tool 213 may recommend components 266 and 268 in response to the user selecting components 260, 261, 262, and 264. In other words, the user may control the number of components used by the tool 213 to determine the recommendation. That is, in certain instances, the user may select all components 260, 261, 262, 264, 266, 268 in the circuit design 220 and the tool 213 may generate the recommendation based on all of the components 260, 261, 262, 264, 266, 268. In other instances, the user may select a subset of the components, such as components 260, 261, and 262, and the tool 213 may generate the recommendation based on a subset of the components 260, 261, and 262. Still in other instances, the user may select one component, such as component 260, and the tool 213 may generate the recommendation based on the one selected component 260. As such, the user may provide an input to the tool 213 for the recommendation, which may improve the recommendation provided by the tool 213.

The tool 213 may provide a visual distinction between the selected components 260, 261, 262, 264, 266, 268 and the recommend component 269 to highlight the recommended component 269 to the user. For example, the recommended component 269 is represented by dashed lines, which may indicate that the recommended component 269 may be a recommendation provided by the tool 213. The tool 213 may also suggest one or more recommended connection components 278 to couple the recommended component 269 to the third component 261. The tool 213 may provide the recommended connection component 278 with dashed lines to illustrate the recommendation to the user.

In certain instances, the tool 213 may identify multiple recommended components 269 and present the recommended components 269 in an order from most likely to be accepted by the user to least likely to be accepted by the user. For example, the tool 213 may provide a first recommended component 269 to the user and an overlay 280 with a description of the first recommended component 269. The overlay 280 may also include a forward arrow and back arrow to allow the user to toggle through the recommended components 269. The tool 213 may update the overlay 280 with the respective description corresponding to the recommended component 269. Additionally or alternatively, the user may toggle through the recommended using a right arrow key and a left arrow key. The user may select a recommended component 269 by pressing an Enter key and may remove the recommended component 269 from the user interface 208 by pressing an Esc key.

If the user accepts the recommended component 269, the tool 213 may adjust the visual representation of the recommended component 269. For example, the recommended component 269 may be visually represented using a solid line, a black color, 100% opacity, and so on. As such, the tool 213 may implement the recommended component 269 into the circuit design 220, thereby reducing a number of steps performed by the user.

In an embodiment, the tool 213 may display all recommendations. To this end, the tool 213 may populate the user interface 208 with a table or a chart including a text description for each respective recommendation. As such, the user may quickly and efficiently view all of the recommendations.

FIG. 5 is a schematic diagram of the user interface 208 as a patch panel populated with a block representation of the circuit design 220 that includes a selected component 310 and a recommended component 312. As illustrated, the tool 213 may populate the user interface 208 with a text description of the selected component 310 and a text description of one or more interface(s) of the selected component 310. As illustrated, the selected component 310 may be a reset bridge with three interfaces. The tool 213 may also provide connection points adjacent to each of the interfaces for user interactions.

Based on the selected component 310, the tool 213 may identify a recommended component 312. For example, the recommended component 312 a clock bridge with a clock input and a clock output. The tool 213 may present the recommended component 312 with shading to illustrate the recommendation to the user. The tool 213 may also provide a recommended connection component 314 to couple the selected component 310 and the recommended component 312.

In certain instances, the user may accept the recommended component 312 and/or the recommended connection component 314. For example, the user may select (e.g., click) the recommended component 312 to add the recommended component 312 to the circuit design 220. Additionally or alternatively, the user may select the recommended connection component 314 to add both the recommended component 312 and the recommended connection component 314 to the circuit design 220. The tool 213 may also provide the user input of accepting the recommendation to the machine-learning technique as training data.

In other instances, the user may decline the recommendation. For example, the user may click a portion of the user interface 208 outside of the recommended component 312. The tool 213 may remove the recommended component 312 from the user interface 208. That is, the circuit design 220 may only include the selected component 310. The tool 213 may also provide the user input of declining the recommendation to the machine-learning technique as training data.

In certain instances, the user interface 208 may also include an input box 316. The user may input a text description related to one or more component(s) and/or a functionality of the circuit design 220. For example, the user may input “Clock Bridge” into the input box 316 and the tool 213 may populate the user interface 208 with the clock bridge component (e.g., the selected component 310), thereby reducing a number of steps performed by the user to generate the circuit design 220. Additionally or alternatively, the tool 213 may populate the user interface 208 with the recommended component 312.

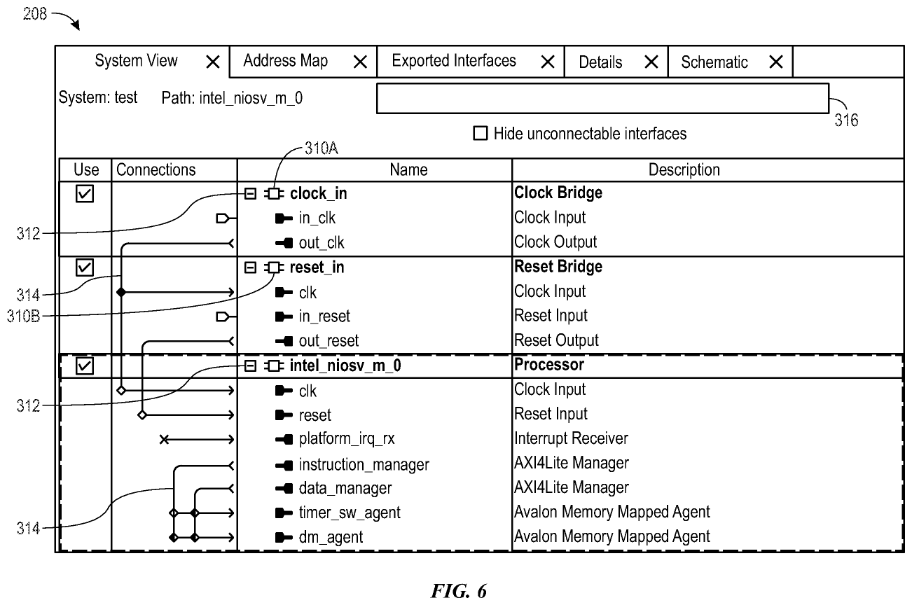

FIG. 6 is a schematic diagram of the user interface 208 as a patch panel populated with a visual representation of the circuit design 220 that includes selected components 310A, 310B and a recommended component 312. The user interface 208 illustrated in FIG. 6 is substantially similar to the user interface 208 described with respect to FIG. 5 except the user interface 208 illustrates a Clock Bridge and a Reset Bridge as selected components 310A, 310B and a processor as the recommended component 312. The recommended connection component 314 may be implemented into the circuit design 220 as the connection component 311.

The tool 213 may identify a processor as the recommended component 312 based on the selected components 310A, 310B. For example, the tool 213 may determine the processor based on previous user input indicative of selecting the processor subsequent to selecting the Clock Bridge and the Reset Bridge. In another example, the tool 213 may identify a relationship between the recommended component 312 and the selected components 310A, 310B from completed circuit designs 220 used to train the machine-learning technique. Additionally or alternatively, the user may populate the input box 316 with the phrase ‘processor’ and the tool 213 may populate the user interface 208 with the Clock Bridge and the Reset Bridge as the first selected component 310A and the second selected component 310B and the processor as either a third selected component 310C or a recommended component 312.

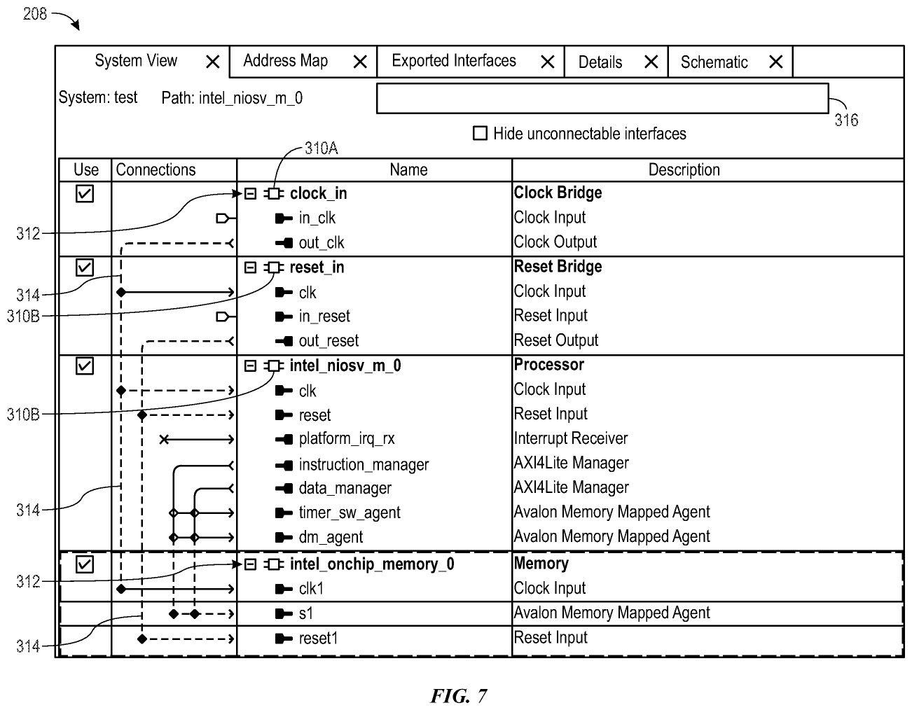

FIG. 7 is a schematic diagram of the user interface 208 as a patch panel populated with a visual representation of the circuit design 220 that includes selected components 310A, 310B, 310C and a recommended component 312. The user interface 208 illustrated in FIG. 6 is substantially similar to the user interface 208 described with respect to FIG. 5 except the user interface 208 illustrates the Clock Bridge, the Reset Bridge, and the processor as selected components 310A, 310B, 310C and a memory as the recommended component 312.

As discussed herein, the tool 213 may identify the recommended component 312 based on the selected components 310A, 310B, 310C. For example, the tool 213 may recommend a memory for hosting a software execution program and/or data used by the processor. The user may provide an indication of accepting the recommendation by clicking on the recommended component 312 or declining the recommendation by clicking on an area of the user interface 208 without the recommended component 312.

Additionally or alternatively, the tool 213 may provide one or more recommended connection components 314 to couple the selected component 310A, 310B, 310C and the recommended component 312. For example, the tool 213 may provide multiple recommended connection components 314 coupling one or more interfaces of the recommended component 312 to one or more interfaces of respective selected components 310A, 310B, 310C. As illustrated, the tool 213 provided a recommended connection component 314 between a clock output interface of the Clock Bridge to a clock input interface of the memory and a reset output interface of the Reset Bridge to a reset input interface of the memory. The tool 213 may also provide a recommended connection component 314 between the clock output interface of the Clock Bridge and the clock input interface of the processor, a reset output interface of the Reset Bridge and a reset input interface of the memory, and so on. In this way, the tool 213 may provide recommended connection components 314 between each of the selected components 310A, 310B, 310C and/or the recommended component 312.

The user may provide an indication of accepting all of the recommended connection components 314, a portion of the recommended connection components 314, declining all of the recommended connection components 314, and/or declining a portion of the recommended connection components 314. For example, the user may press the Enter key to select all of the recommended connection components 314 or the Esc key to decline all of the recommended connection components 314. In another example, the user may press the Shift key and click on one or more recommended connection components 314 to accept a portion of the recommended connection components 314 and decline the remainder of the recommended connection components 314. The tool 213 may implement the accepted recommendations into the circuit design 220 by visually updating the accepted recommended connection components 314. For example, the tool 213 may display the accepted recommended connection components 314 with solid black lines instead of dashed lines.

Additionally or alternatively, the user may manually couple the selected components 310A, 310B, 310C and/or the recommended component 312 by selecting (e.g., clicking on) an interface of a first component and subsequently selecting an interface of a second component. The tool 213 may provide a visual indication of the coupling as a connection component on the user interface 208. In certain instances, the tool 213 may identify the user input as an incorrect connection between the first component and the second component. For example, the user may connect the clock input interface of the Clock Bridge to an interrupt receiver interface of the processor. The tool 213 may provide a recommended connection component 314 from the clock input interface of the Clock Bridge to the clock input interface of the processor. The tool 213 may overlay the recommended connection component 314 over the connection component instantiated by the user to provide a visual indication of the recommendation. In this way, the tool 213 may reduce a number of errors that may stem from human errors.

Although the illustrated examples of FIGS. 5-7 include a circuit design 220 with a clock bridge, a reset bridge, a processor, and a memory, it may be understood that any suitable components may be selected by the user and/or recommended by the tool 213 for implementation in the circuit design 220. For example, the circuit design 220 may include input-output elements, lookup tables, multiplexers, DSP 120, switches, sector controllers, customized components, and so on.

FIG. 8 is a schematic diagram of the user interface 208 as a schematic UI populated with a visual representation of the circuit design 220 that includes two selected components 310A, 310B as an initial point in starting a circuit design 220. As discussed herein, the user interface 208 may include the input box 316 and/or buttons 318, 320. The buttons 318, 320 may facilitate updating (e.g., adjusting) the recommended connection component 314 being displayed. For example, the user may toggle through different recommended connection components 314 by pressing the forward button 318 or the back button 320.

As illustrated, a first selected component 310A includes a reset bridge with three interfaces and the second selected component 310B may be a clock bridge with two interfaces. The tool 213 may couple the first selected component 310A and the second selected component 310B via a connection component 311. That is, the tool 213 may couple the connection component 311 to a first interface of the first selected component 310A and a first interface of the second selected component 310B. As illustrated, the tool 213 may couple the connection component 311 to a clock output interface of the clock bridge to a clock input interface of the reset bridge.

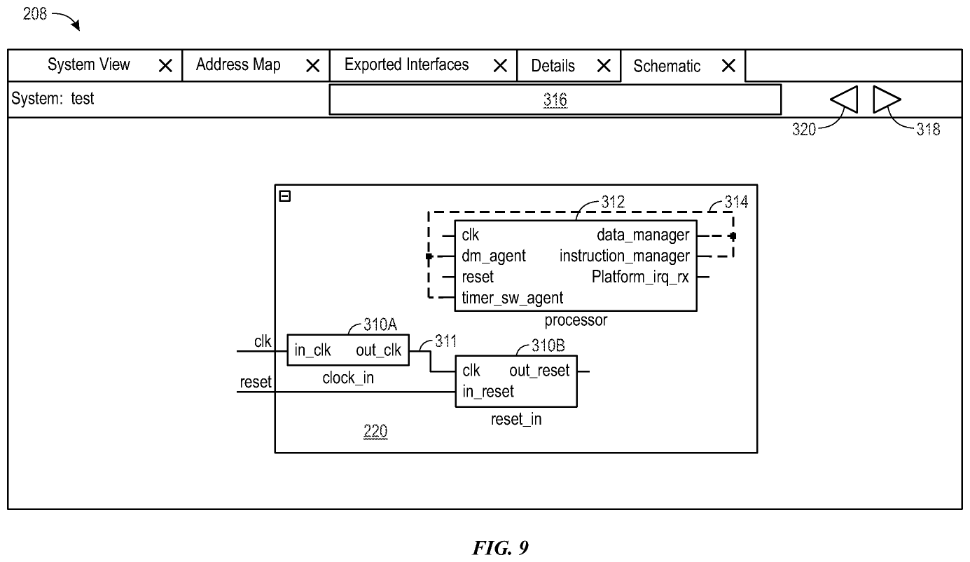

FIG. 9 is a schematic diagram of the user interface 208 as a schematic UI populated with a visual representation of the circuit design 220 that includes selected components 310A, 310B and a recommended component 312. The user interface 208 illustrated in FIG. 9 is substantially similar to the user interface 208 described with respect to FIG. 8 except the user interface 208 includes a recommended component 312. As illustrated, the recommended component 312 may be a processor with seven interfaces.

As discussed herein, the tool 213 may identify the recommended component 312 based on past user input, the machine-learning techniques, the selected components 310A, 310B, and the like. To distinguish between the selected components 310A, 310B and the recommended component 312, the tool 213 may provide a visual distinction between the components. As illustrated, the selected components 310A, 310B may be represented with shading while the recommended component 312 may be represented without shading. In another example, the tool 213 may represent the selected components 310A, 310B at 100% opacity and represent the recommended component 312 at a lower opacity (e.g., 30% opacity, 40% opacity, 50% opacity, 60% opacity). In this way, the user may view the user interface 208 and quickly identify the recommendation provided by the tool. Additionally or alternatively, the user may provide an indication of adding the processor to the circuit design 220. For example, the user may input ‘processor’ into the input box 316 and the tool 213 may populate the user interface 208 with the recommended component 312.

Additionally or alternatively, the tool 213 may provide one or more recommended connection components 314. The tool 213 may provide a visual representation of the recommended connection components 314 as dashed lines. As such, the user may view the user interface 208 and quickly identify the recommendation. As illustrated, the tool 213 may provide the recommended connection components 314 coupling to interfaces of the recommended component 312. For example, the tool 213 may provide a first recommended connection component 314 between an instruction manager interface to a memory mapped agent interface and a second recommended connection component 314 between a data manager interface to a second memory mapped agent interface. The user may accept one or both of the recommended connection components 314 by providing an indication, such as pressing the Enter key, an arrow, a click, and the like. For example, the user may provide an indication of declining the recommendation by pressing the forward arrow key. In response to receiving the indication, the tool 213 may update the user interface to present a different set of connections between the components. In another example, the user may provide an indication of approving the recommendation, such as pressing the Enter key. In response to receiving the indication, the tool 213 may update the user interface 208 to present the recommended connection components 314 as connection components 311 in solid lines. In this way, fewer operations may be performed by the user to generate the circuit design 220.

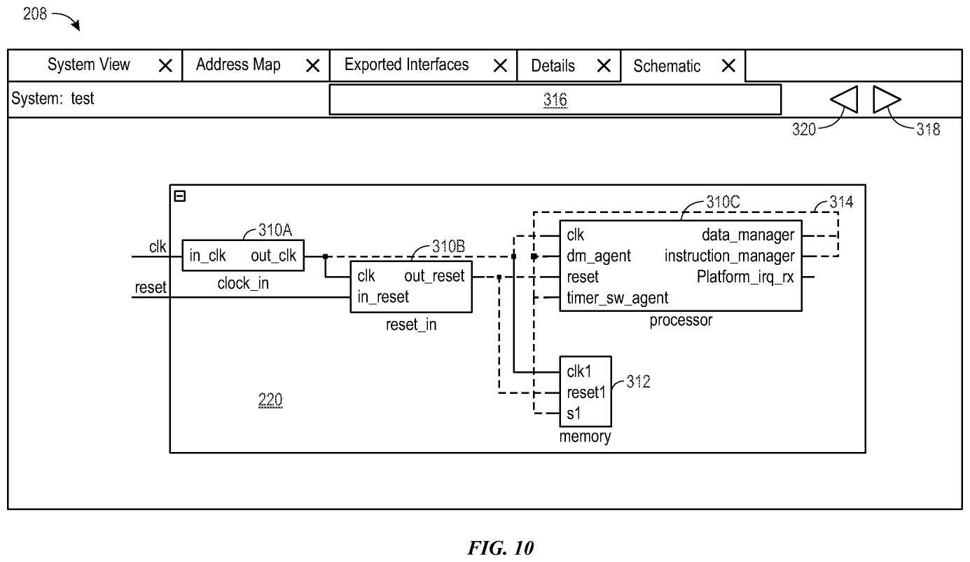

FIG. 10 is a schematic diagram of the user interface 208 as a schematic UI populated with a visual representation of the circuit design 220 that includes selected components 310 and a recommended component 312. The user interface 208 illustrated in FIG. 10 is substantially similar to the user interface 208 described with respect to FIG. 9 except the user interface 208 of FIG. 10 illustrates a Clock Bridge, a Reset Bridge, and a processor as selected components 310A, 310B, 310C and a memory as the recommended component 312.

The tool 213 may identify and recommend the memory based on the processor being implemented in the circuit design 220. For example, the tool 213 may understand that the circuit design 220 may use the memory to host a software execution program and/or data used by the processor. That is, the tool 213 may understand a relationship between the memory and the processor. As discussed herein, the tool 213 may identify the recommended component 312 based on the selected components 310A, 310B, 310C, the connection components 311, and/or the machine-learning techniques. As illustrated, the tool 213 may provide the recommended connection component 314 in a manner that may be visually distinct from the selected components 310.

In certain instances, the user may accept the recommendation to add the recommended component 312 to the circuit design 220. As such, the tool 213 may update the user interface 208 to adjust the representation of the recommended component 312 to match the representation of the selected components 310. In other instances, the user may decline the recommendation and the tool 213 may remove the recommended connection component 314 from the user interface 308.

Additionally or alternatively, the tool 213 may provide one or more recommended connection components 314 between the selected components 310A, 310B, 310C and/or the recommended component 312. For example, as illustrated, the tool 213 may provide a first recommended connection component 314 between the clock input interface of the processor to the clock output interface of the Clock Bridge to an clock input interface of the memory, a second recommended connection component 314 between the reset interface of the processor, the reset interface of the Reset Bridge, and the reset interface of the memory, a third recommended connection component 314 from a data manager of the processor to an memory mapped agent interface of the memory. As discussed herein, the user may accept all of the recommendations, accept a portion of the recommendations, decline all of the recommendations, and/or decline a portion of the recommendations. Based on the user input, the tool 213 may update the user interface 208 with an updated circuit design 220. Additionally or alternatively, the tool 213 may provide the user input to the machine-learning techniques as training data.

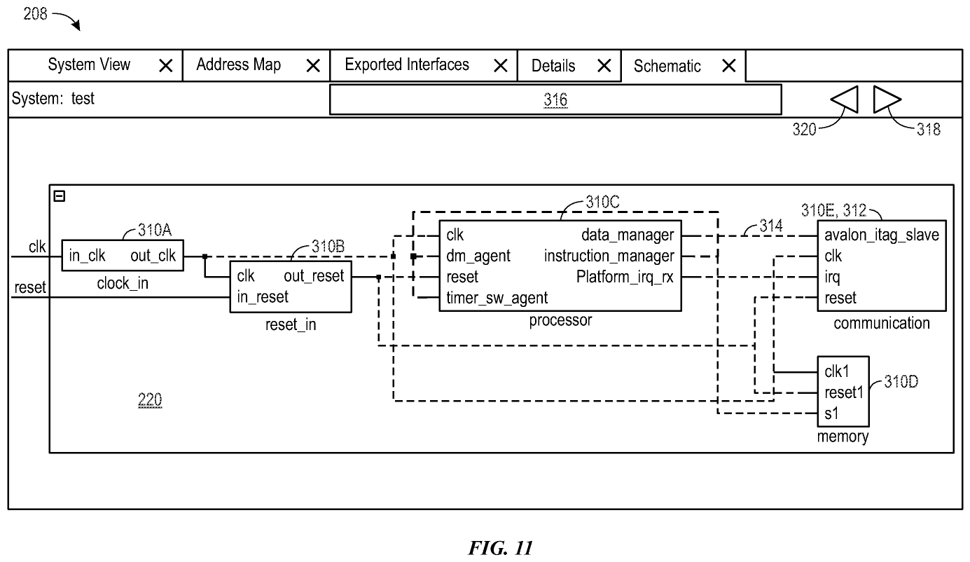

With the foregoing in mind, FIG. 11 is a schematic diagram of the user interface 208 as a schematic UI populated with a visual representation of the circuit design 220 that includes selected components 310 and recommended components 312. The user interface 208 illustrated in FIG. 11 is substantially similar to the user interface 208 described with respect to FIG. 10 except the user interface 208 illustrates the Clock Bridge, the Reset Bridge, the processor, and the memory as the selected components 310A, 310B, 310C, 310D and an asynchronous serial communication (JTAG UART) as the recommended component 312. For example, the user may press the tab key or a forward arrow button and the tool 213 may populate the user interface 208 with the JTAG UART as the recommended component 312. The tool 213 may also provide a recommended connection component 314 to couple one or more interfaces of the recommended component 312 to one of the selected components 310A, 310B, 310C, 310D. For example, the tool 213 may provide the recommended connection component 314 from a memory mapped agent of the JTAG UART to the data manager of the processor.

In certain instances, the user may decline the recommendations. For example, the user may click an area of the user interface 208 that does not correspond to the recommended component 312 and/or the recommended connection component 314. In another example, the user may press the Esc key and the tool 213 may update the user interface 208 to not include the recommended component 312 and/or the recommended connection component 314.

In other instances, the user may accept a portion of the recommendations. For example, the user may select the recommended component 312 to provide an indication of accepting only the recommended component 312. The tool 213 may update the visual representation of the recommended component 312 to match the visual representation of the selected components 310A, 310B, 310C, 310D. The user may manually couple the newly selected component 310E by selecting an interface of the newly selected component 310E and subsequently selecting an interface of one of the selected components 310A, 310B, 310C, 310D.

In certain instances, the user may accept both the recommended component 312 and the recommended connection component 314 by clicking on the components, pressing the Enter key, or the like. In response to this indication, the tool 213 may update the visual representation of the recommended component 312 and the recommended connection component 314 from dashed lines and/or no shading to solid lines and/or shading to illustrate the acceptance. That is, the recommended component 312 and/or the recommended connection component 314 may be implemented into the circuit design 220 and transition to a selected component 310E and a connection component 311. As such, the tool 213 may reduce a number of operations performed by the user to generate the circuit design 220.

Continuing with the example of FIG. 11, the user may add and/or the tool 213 may recommend an external memory interface (EMIF) to the circuit design 220. The tool 213 may provide a first recommended connection component 314 coupling a data port interface of the EMIF component to an instruction manager interface of the processor and a second recommended connection component 314 coupling the data port interface of the EMIF to a data manager of the processor. To view and/or accept the recommended connection components 314 separately, the user may press a Tab key or the forward button 318 in the user interface 208 and the tool 213 may show only the first recommended connection component 314 between the data interface of the EMIF to the data manager interface of the processor. The user may press the Enter key to accept the first recommended connection component 314. Additionally or alternatively, the user may press the Tab key or the forward button 318 a second time and the tool 213 may show only the second recommended connection component 314.

In certain instances, the user may press the Tab key or the forward button 318 and the tool 213 may provide additional recommended connection components 314. For example, the tool 213 may recommend a Pipeline Bridge to bridge the data manager interface of the EMIF and the data manager interface of the processor. That is, the tool 213 may provide an additional recommended connection component 312 and one or more recommended connection components 314 to generate the circuit design 220. The user may accept the recommendations, accept a portion of the recommendations, decline the recommendation, and/or decline a portion of the recommendation. Additionally or alternatively, the user may provide an indication to export the circuit design 220 and the tool 213 may provide the circuit design 220 in a low-level hardware description language to a compiler 16 for compilation and subsequently to for implementation on the integrated circuit system 12.

In certain instances, the tool 213 may suggest multiple components at one time. For example, the tool 213 may recommend the JTAG UART, the EMIF, and the Pipeline Bridge in response to the user selecting the memory and/or processor. The user may press the Enter key to accept all of the recommended components together, thereby reducing an amount of time used to generate the circuit design and/or the number of operations performed by the user. In another example, the user may select a portion of the recommendations, such as the EMIF and the Pipeline Bridge, which reduce a number of operations performed by the user. Still in another example, the user may press the Esc key to remove recommendations from the user interface 208. In this way, design efficiency may be improved.

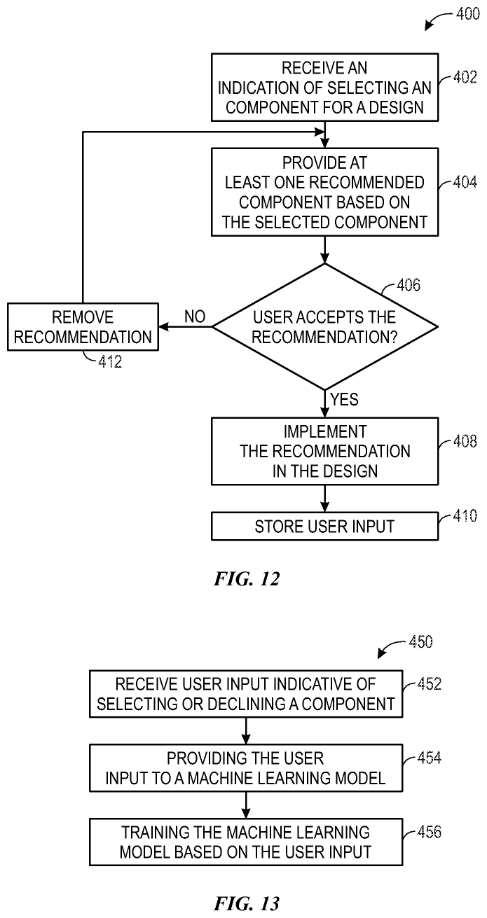

FIG. 12 is a flowchart of an example method for creating a design for an FPGA. The method 400 may be performed by the processor-based device 202 described with respect to FIG. 3. The method 400 includes various steps represented by blocks. Although the flowchart illustrates the steps in a certain sequence, it should be understood that the steps may be performed in any suitable order and certain steps may be carried out simultaneously, where appropriate. Further, certain steps or portions of the method 400 may be performed by separate systems or devices.

At block 402, an indication of selecting a component for a design may be received. For example, the user may select a component from a database for implementing into a circuit design. In another example, the user may select multiple components from the database. In response to receiving the indication of selecting the component, the tool may populate the user interface with a visual representation of the selected component(s).

At block 404, at least one recommended component based on the selected component may be provided. As discussed herein, the tool may implement machine-learning techniques that may be trained based on completed circuit designs, previous user input, previous input from other users, and so on. The tool may identify one or more recommended components based on the selected component based on the selected component. The recommended component may be an additional component that may be coupled to the selected component. Additionally or alternatively, the recommended component may be a connection component from the selected component to another component and/or an additional component. For example, the user may select a processor component and the tool may recommend a connection from the processor component to a reset component. In another example, the user may select a memory component and the tool may recommend a bridge component and a connection between the two components. The tool may update the user interface to provide a visual indication of the recommendation. As discussed herein, the recommendation may be presented in manner that distinguishes the recommendation from implemented components.

At determination block 406, a determination of a user accepting the recommendation may be made. For example, the tool may receive an indication from the user indicative of approving or declining the recommendation. In certain instances, the user may press a key, such as a forward key, a back key, an Esc key, an Enter key, and so on to provide the indication. In other instances, the user may press a button within the user interface, such as a forward button or a backwards button to provide the indication. Still in another instance, the user may click on the recommended component or click an area of the user interface that does not include the recommended component to provide the indication.

If the recommendation is accepted, at block 408, the recommendation may be implemented into the design. For example, the user may click on the recommendation and the tool may receive an indication of accepting the recommendation from the user. In another example, the user may press the Enter button to accept all recommendations displayed within the user interface. The tool may update the user interface based on the accepted recommendation. For example, the tool may illustrate the accepted recommendation with solid lines instead of dashed lines to indicate the recommendation being implemented into the design.

At block 410, the user input may be stored. For example, the user input (e.g., indication of accepting the recommendation) may be stored in the memory and/or the database. Additionally or alternatively, the user input may be provided to train the machine-learning techniques. For example, the user response may be stored in the training set and/or counted in the training set used to train the natural language model. In addition, a text description of the recommended component and the selected component may be provided to train the natural language model. In this way, the model may identify relationships between the components, user preferences, and the like. Over time, the model may be tailored to the user and trained based on the user accepting and/or declining the recommendations. As such, the recommendations over time may range from highly specific, to loosely correlated from similar patterns applied to other designs (e.g., previous designs, other designs). In the case of highly specific, the machine-learning techniques may provide an exact suggestion based on a precise match of previous steps provided by other users in the past. As such, the tool may provide likely components for implementing into the design, thereby improving design efficiency for the user.

If the recommendation is not accepted, at block 412, the recommendation may be removed. For example, the user may provide an indication to view a subsequent recommendation and the tool may update the user interface to display different recommended component. The tool may adjust the user interface to display only selected components implemented in the design. Additionally or alternatively, the tool may update the user interface with a different recommended component. For example, the user may press the Tab key or the forward button to toggle through different recommended components provided by the tool. In another example, the user may provide an indication to remove all recommendations from the user interface. The user may press the Esc key and the tool may update the user interface to display only the selected components.

The method 400 may return to block 410 to store the user input. For example, the tool may save the user input indicative of removing all recommendations to the memory and/or provide the user input to the machine-learning technique. Additionally or alternatively, the tool may provide a layout of the design at the point in time when the user declined the recommendation, the type of component declined by the user, the other implemented components, and the like to the machine-learning technique to improve subsequent recommendations. In this way, the machine-learning techniques may be trained based on the user inputs, which may improve the recommendations provided to the user. For example, the tool may learn, over time, to provide recommendations tailored to the user.

FIG. 13 is a flowchart of an example method for training the machine-learning techniques used by the tool. The method 450 may be performed by the processor-based device described with respect to FIG. 3. The method 450 includes various steps represented by blocks. Although the flowchart illustrates the steps in a certain sequence, it should be understood that the steps may be performed in any suitable order and certain steps may be carried out simultaneously, where appropriate. Further, certain steps or portions of the method 450 may be performed by separate systems or devices.

At block 452, a user input indicative of selecting or declining a component may be received. For example, may accept all of the recommendations, accept a portion of the recommendations, decline a portion of the recommendations, decline all of the recommendations, and so on.

At block 454, the user input may be provided to a machine-learning technique. By way of example, the machine-learning technique may be a natural language model. The model may be trained using completed circuit designs and subsequently trained overtime based on the user input. For example, the model may implement (e.g., incorporate) a form of reinforcement learning from human feedback (RLHF). In this way, the model may be tailored to user preferences and/or user patterns over time. For example, the model may be provided with a text description of the accepted recommended component and/or all selected components may be provided to the model. In another example, a text description of a declined recommended component may be provided and/or all selected components.

At block 456, the machine-learning technique may be trained based on the user input. For example, the machine-learning technique may identify user preferences, user patterns, and/or relationships between the components based on the user input. Additionally or alternatively, the model may be trained based on new circuit designs and/or the preferences of other users. In this way, the tool may identify a most likely component for implementing in the circuit design based on already selected components and improve efficiency of design operations.

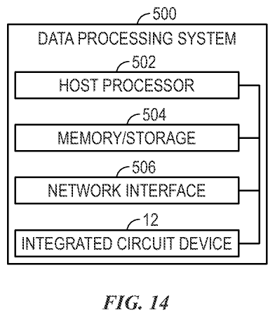

The circuit discussed above may be implemented on the integrated circuit system 12, which may be a component included in a data processing system, such as a data processing system 500, shown in FIG. 14. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 14 may include the integrated circuit system 12 implementing a design generated by the application 211 and/or aided by the tool 213. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

As used herein, machine learning may refer to algorithms and statistical models that computer systems may use to perform a specific task with or without using explicit instructions. For example, a machine learning process may generate a mathematical model based on a sample of clean data, known as “training data,” in order to make predictions or decisions without being explicitly programmed to perform the task. In another example, the machine learning process may use image analysis to determine objects of interest based on a sample of clean data or based on preferences by a user, in order to make recommendations or decisions being explicitly programmed to perform the task.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A system may include a processor-based device storing or accessing a computer-aided design application for an integrated circuit, wherein the computer-aided design application, when executed by the processor-based device, causes acts to be performed comprising receiving an indication of a first selected component from a database for a design for the integrated circuit, retrieving one or more recommended components from the database based at least in part on the first selected component, and populating a user interface with the first selected component and a first recommended component of the one or more recommended components for display on the processor-based device.

EXAMPLE EMBODIMENT 2. The system of example embodiment 1, wherein the first selected component is displayed using solid lines and the first recommended component is displayed using dashed lines.

EXAMPLE EMBODIMENT 3. The system of example embodiment 1, wherein the computer-aided design application, when executed, causes acts to be performed comprising populating the user interface with an overlay comprising a text description of the first recommended component, a first button, and a second button.

EXAMPLE EMBODIMENT 4. The system of example embodiment 3, wherein the computer-aided design application, when executed, causes acts to be performed comprising receiving a second indication via the first button or the second button of skipping the first recommended component, populating a second recommended component of the one or more recommended components based at least in part on receiving the second indication, and updating the overlay with a text description of the second recommended component.

EXAMPLE EMBODIMENT 5. The system of example embodiment 1, wherein the computer-aided design application, when executed, causes acts to be performed comprising receiving a second indication of selecting a second recommended component of the one or more recommended components and coupling the second recommended component with the first selected component via a recommended connection component.

EXAMPLE EMBODIMENT 6. The system of example embodiment 5, wherein the computer-aided design application, when executed, causes acts to be performed comprising receiving a third indication of accepting the second recommended component and the recommended connection component for the design.

EXAMPLE EMBODIMENT 7. The system of example embodiment 6, wherein the computer-aided design application, when executed, causes acts to be performed comprising storing the design in the database and providing the design as training data to a machine-learning model.

EXAMPLE EMBODIMENT 8. The system of example embodiment 1, wherein the computer-aided design application, when executed, causes acts to be performed comprising receiving a second indication of coupling a first interface of the first selected component to a first interface of the first recommended component and populating the user interface with a first recommended connection component coupling a second interface of the first selected component to a first interface of the first recommended component in response to determining the coupling between the first interface of the first selected component to the first interface of the first recommended component is incorrect.

EXAMPLE EMBODIMENT 9. The system of example embodiment 1, comprising a machine learning model, wherein the computer-aided design application, when executed causes acts to be performed comprising receiving a second indication of declining the first recommended component and populating the user interface with the first selected component.

EXAMPLE EMBODIMENT 10. The system of example embodiment 1, wherein the computer-aided design application, when executed, causes acts to be performed comprising receiving a text description corresponding to a second component via an input box and populating the user interface with the first selected component and the second component.

EXAMPLE EMBODIMENT 11. A method may include receiving, via a processor, an indication of a first selected component from a database for a design for an integrated circuit, retrieving, via the processor and a tool, one or more recommended components from the database based at least in part on the first selected component, and instructing, via the processor, a user interface to display the first selected component and a first recommended component of the one or more recommended components for display on a processor-based device.

EXAMPLE EMBODIMENT 12. The method of example embodiment 11, comprising instructing, via the processor, the user interface to display the first selected component and a second recommended component of the one or more recommended components based at least in part on receiving a second indication of declining the first recommended component, wherein the second indication is provided by a button or a key.

EXAMPLE EMBODIMENT 13. The method of example embodiment 11, comprising identifying, via the processor and the tool, a recommended connection component coupling an interface of the first selected component and an interface of the first recommended component and instructing, via the processor, the user interface to display the first selected component, the first recommended component, and the recommended connection component.

EXAMPLE EMBODIMENT 14. The method of example embodiment 13, comprising receiving, via the processor, a second indication of accepting the first recommended component and the recommended connection component for the design, implementing, via the processor, the first recommended component as a second selected component, and instructing, via the processor, the user interface to adjust a visual representation of the second selected component and the recommended connection component to match a visual representation of the first selected component.

EXAMPLE EMBODIMENT 15. The method of example embodiment 11, comprising receiving, via the processor and an input box, a text description corresponding to a second component in the database, identifying, via the processor and the tool, the second component in the database, and instructing, via the processor, a user interface to display the second component for display on the processor-based device.

EXAMPLE EMBODIMENT 16. A non-transitory, computer-readable medium comprising computer-readable code, that when executed by one or more processors, causes the one or more processors to perform operations comprising receiving an indication of a first selected component from a database for a design for an integrated circuit, retrieving a plurality of recommended components from the database based at least in part on the first selected component, and instructing a user interface to display the first selected component and a first recommended component of the plurality of recommended components for display on a processor-based device, wherein a visual representation of the first recommended component is different from a visual representation of the first selected component.

EXAMPLE EMBODIMENT 17. The non-transitory, computer-readable medium of example embodiment 16, wherein the one or more processors are configurable to perform operations comprising instructing the user interface to display an overlay adjacent to the first recommended component, where the overlay comprises a text description corresponding to the first recommended component. The one or more processors are also configurable to perform operations including instructing the user interface to display the first selected component and a second recommended component in response to receiving a second indication to view a different component of the plurality of recommended components and updating the overlay with a text description corresponding to the second recommended component.

EXAMPLE EMBODIMENT 18. The non-transitory, computer-readable medium of example embodiment 16, wherein the one or more processors are configurable to perform operations comprising adjusting the visual representation of the first recommended component in response to receiving a second indication of accepting the first recommended component, wherein the visual representation of the first recommended component matches the visual representation of the first selected component and identifying a second plurality of recommended components in the database based at least in part on the first recommended component.

EXAMPLE EMBODIMENT 19. The non-transitory, computer-readable medium of example embodiment 18, wherein the one or more processors are configurable to perform operations comprising receiving a third indication of a connection component coupling a first interface of the first selected component and a first interface of the first recommended component and instructing the user interface to display the connection component and a recommended connection component between a first interface of the first selected component and a second interface of the first recommended component in response to determining the connection component is incorrectly coupled.

EXAMPLE EMBODIMENT 20. The non-transitory, computer-readable medium of example embodiment 16, wherein the one or more processors are configurable to perform operations comprising receiving a second indication of publishing the design for the integrated circuit, providing the design to a compiler as a low-level language description, and implementing the design onto the integrated circuit.

What is claimed is:

1. A system comprising:
a processor-based device storing or accessing a computer-aided design application for an integrated circuit, wherein the computer-aided design application, when executed by the processor-based device, causes acts to be performed comprising:
receiving an indication of a first selected component from a database for a design for the integrated circuit;
retrieving one or more recommended components from the database based at least in part on the first selected component; and
populating a user interface with the first selected component and a first recommended component of the one or more recommended components for display on the processor-based device.

2. The system of claim 1, wherein the first selected component is displayed using solid lines and the first recommended component is displayed using dashed lines.

3. The system of claim 1, wherein the computer-aided design application, when executed, causes acts to be performed comprising:
populating the user interface with an overlay comprising a text description of the first recommended component, a first button, and a second button.

4. The system of claim 3, wherein the computer-aided design application, when executed, causes acts to be performed comprising:
receiving a second indication via the first button or the second button of skipping the first recommended component;
populating a second recommended component of the one or more recommended components based at least in part on receiving the second indication; and
updating the overlay with a text description of the second recommended component.

5. The system of claim 1, wherein the computer-aided design application, when executed, causes acts to be performed comprising:
receiving a second indication of selecting a second recommended component of the one or more recommended components; and
coupling the second recommended component with the first selected component via a recommended connection component.

6. The system of claim 5, wherein the computer-aided design application, when executed, causes acts to be performed comprising:
receiving a third indication of accepting the second recommended component and the recommended connection component for the design.

7. The system of claim 6, wherein the computer-aided design application, when executed, causes acts to be performed comprising:
storing the design in the database; and
providing the design as training data to a machine-learning model.

8. The system of claim 1, wherein the computer-aided design application, when executed, causes acts to be performed comprising:
receiving a second indication of coupling a first interface of the first selected component to a first interface of the first recommended component; and
populating the user interface with a first recommended connection component coupling a second interface of the first selected component to a first interface of the first recommended component in response to determining the coupling between the first interface of the first selected component to the first interface of the first recommended component is incorrect.

9. The system of claim 1, comprising a machine learning model, wherein the computer-aided design application, when executed causes acts to be performed comprising:
receiving a second indication of declining the first recommended component; and
populating the user interface with the first selected component.

10. The system of claim 1, wherein the computer-aided design application, when executed, causes acts to be performed comprising:
receiving a text description corresponding to a second component via an input box; and
populating the user interface with the first selected component and the second component.

11. A method comprising:
receiving, via a processor, an indication of a first selected component from a database for a design for an integrated circuit;
retrieving, via the processor and a tool, one or more recommended components from the database based at least in part on the first selected component; and
instructing, via the processor, a user interface to display the first selected component and a first recommended component of the one or more recommended components for display on a processor-based device.

12. The method of claim 11, comprising:
instructing, via the processor, the user interface to display the first selected component and a second recommended component of the one or more recommended components based at least in part on receiving a second indication of declining the first recommended component, wherein the second indication is provided by a button or a key.

13. The method of claim 11, comprising:
identifying, via the processor and the tool, a recommended connection component coupling an interface of the first selected component and an interface of the first recommended component; and
instructing, via the processor, the user interface to display the first selected component, the first recommended component, and the recommended connection component.

14. The method of claim 13, comprising:
receiving, via the processor, a second indication of accepting the first recommended component and the recommended connection component for the design;
implementing, via the processor, the first recommended component as a second selected component; and
instructing, via the processor, the user interface to adjust a visual representation of the second selected component and the recommended connection component to match a visual representation of the first selected component.

15. The method of claim 11, comprising:
receiving, via the processor and an input box, a text description corresponding to a second component in the database;
identifying, via the processor and the tool, the second component in the database; and
instructing, via the processor, a user interface to display the second component for display on the processor-based device.

16. A non-transitory, computer-readable medium comprising computer-readable code, that when executed by one or more processors, causes the one or more processors to perform operations comprising:
receiving an indication of a first selected component from a database for a design for an integrated circuit;
retrieving a plurality of recommended components from the database based at least in part on the first selected component; and
instructing a user interface to display the first selected component and a first recommended component of the plurality of recommended components for display on a processor-based device, wherein a visual representation of the first recommended component is different from a visual representation of the first selected component.

17. The non-transitory, computer-readable medium of claim 16, wherein the one or more processors are configurable to perform operations comprising:
instructing the user interface to display an overlay adjacent to the first recommended component, wherein the overlay comprises a text description corresponding to the first recommended component;
instructing the user interface to display the first selected component and a second recommended component in response to receiving a second indication to view a different component of the plurality of recommended components; and
updating the overlay with a text description corresponding to the second recommended component.

18. The non-transitory, computer-readable medium of claim 16, wherein the one or more processors are configurable to perform operations comprising:
adjusting the visual representation of the first recommended component in response to receiving a second indication of accepting the first recommended component, wherein the visual representation of the first recommended component matches the visual representation of the first selected component; and
identifying a second plurality of recommended components in the database based at least in part on the first recommended component.

19. The non-transitory, computer-readable medium of claim 18, wherein the one or more processors are configurable to perform operations comprising:
receiving a third indication of a connection component coupling a first interface of the first selected component and a first interface of the first recommended component; and
instructing the user interface to display the connection component and a recommended connection component between a first interface of the first selected component and a second interface of the first recommended component in response to determining the connection component is incorrectly coupled.

20. The non-transitory, computer-readable medium of claim 16, wherein the one or more processors are configurable to perform operations comprising:
receiving a second indication of publishing the design for the integrated circuit;
providing the design to a compiler as a low-level language description; and
implementing the design onto the integrated circuit.
